(19) United States
(12) Patent Application Publication
(10) Pub. No.: US 2026/0229931 A1
(43) Pub. Date: Aug. 6, 2026

(54) SYSTEMS FOR STATOR FIXATION

(71) Applicant: Ford Global Technologies, LLC, Dearborn, MI (US)

(72) Inventors: Joel Hetrick, Ann Arbor, MI (US); Jacob Krizan, Farmington Hills, MI (US); Matthew Schmitt, Salt Lake City, UT (US)

(21) Appl. No.: 19/046,418

(22) Filed: Feb. 5, 2025

(51) Int. Cl. H02K 1/18; H02K 1/20

(52) U.S. Cl. CPC H02K 1/18; H02K 1/20

(57) ABSTRACT

Systems are provided for stator fixation in electric machines. In one example, an electric machine includes a housing with evenly distributed recesses adapted to receive protrusions extending radially from a stator. The protrusions include a plurality of tabs which bend upon insertion of the stator into the rotor, thereby fixing the stator concentrically with the housing.

### FIELD

The present description relates generally to systems for stator fixation, specifically fixing a stator to a housing of an electric machine, such as electric motor and/or generator.

### BACKGROUND/SUMMARY

An electric motor may be included in an electrified powertrain for propulsion of a vehicle. The electric motor may comprise a stator and a rotor positioned coaxial with the stator about an axis of rotation of the rotor. Fixation of the stator concentric with the rotor corresponds to load generation and transfer to the rotor, thereby affecting performance of the electric motor, including noise, vibration, and harshness (NVH) levels and efficiency. For example, rotational imbalance of the rotor due to nonconcentric positioning of the stator and the rotor may reduce an output of the rotor, thereby affecting efficiency.

In one example, the issues described above may be at least partially addressed by an electric machine, comprising a laminated circumferential stator including at least three integral radially and outwardly extending protrusions uniformly distributed around a perimeter of the stator, each protrusion comprising tabs. The electric machine further comprises a housing comprising recesses adapted to accommodate the protrusions, where the tabs are adapted to bend upon insertion of the stator into the housing to fix the stator to the housing. In this way, the electric machine disclosed herein with stator fixation achieved via bending tabs may provide a self-aligning mechanism, whereby the tabs positionally locate the stator in a centered position as the opposing tabs balance each other out. With reduced eccentricity, the magnitude of NVH levels and efficiency loss may be reduced. In addition, the relative resource demand and complexity of stamping an ear into each lamination and providing the corresponding recesses on the housing may be less than creating bolt holes and bolts.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 schematically depicts a vehicle including the electric motor in accordance with the present disclosure.

FIG. 2 schematically depicts a cross section of the electric motor.

FIG. 3 shows a perspective view of a stator and housing.

FIG. 4 shows a perspective view of a stator and housing.

FIGS. 5A-5C show ears of the stator.

FIGS. 6A and 6B show ears of the stator.

### DETAILED DESCRIPTION

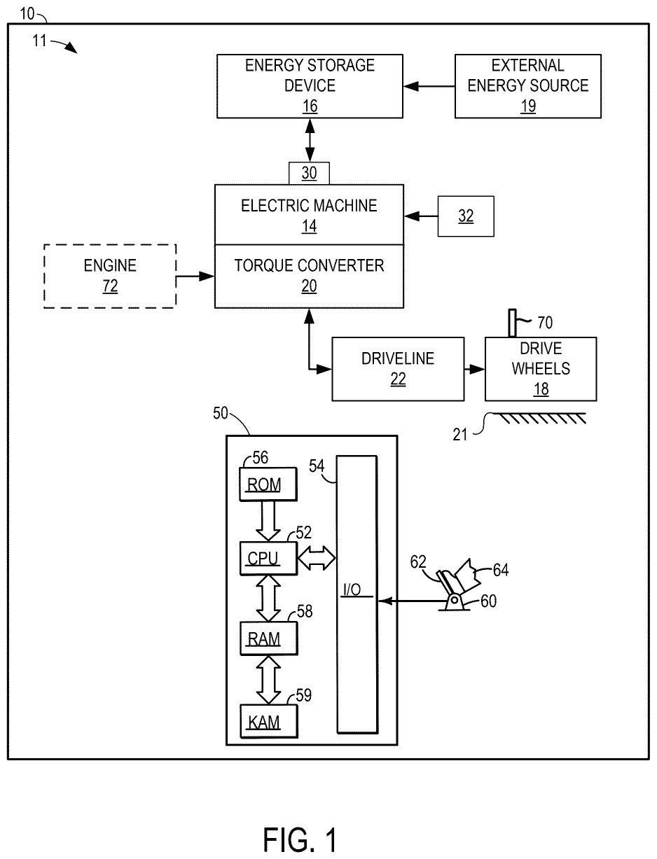

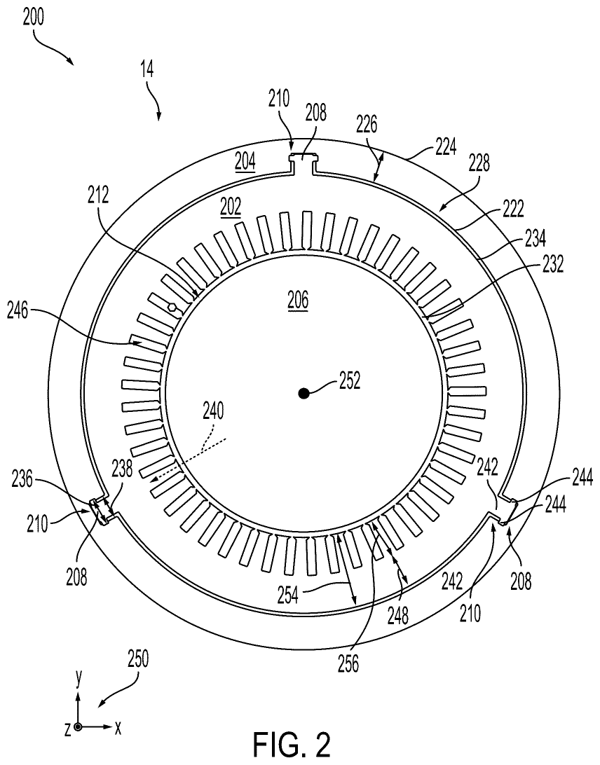

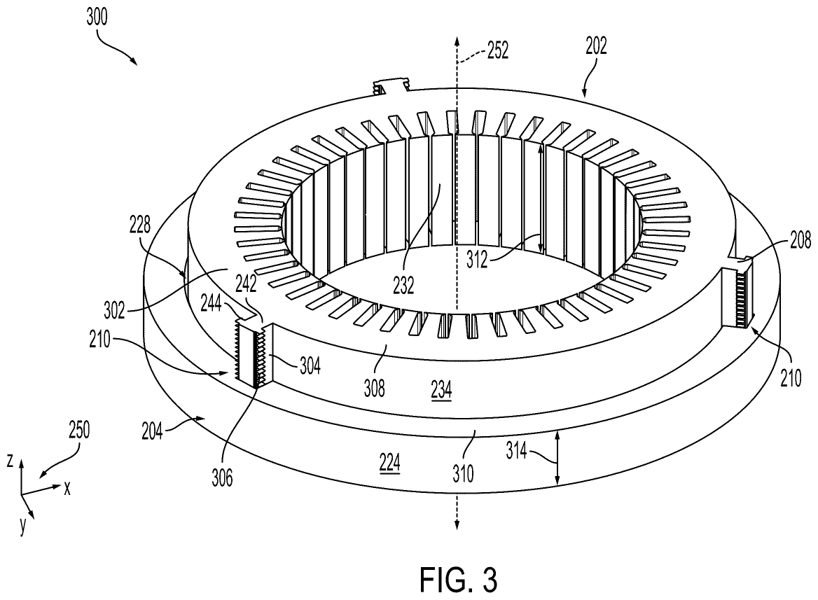

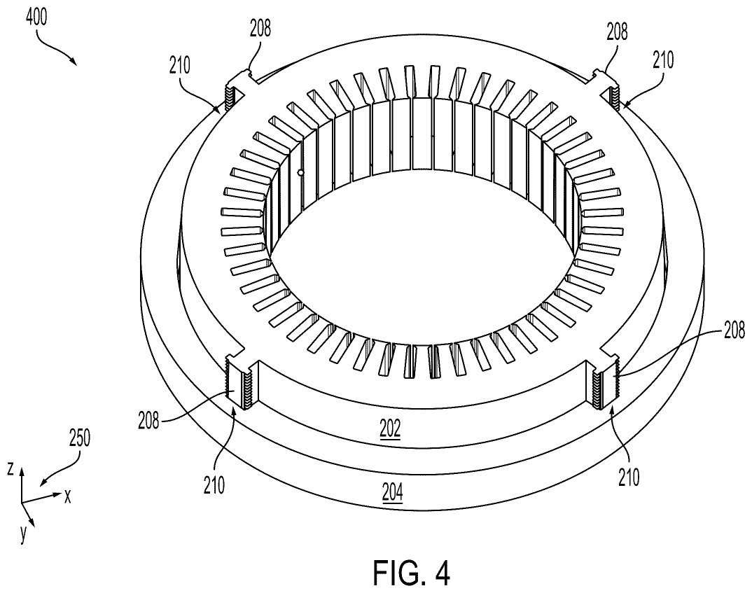

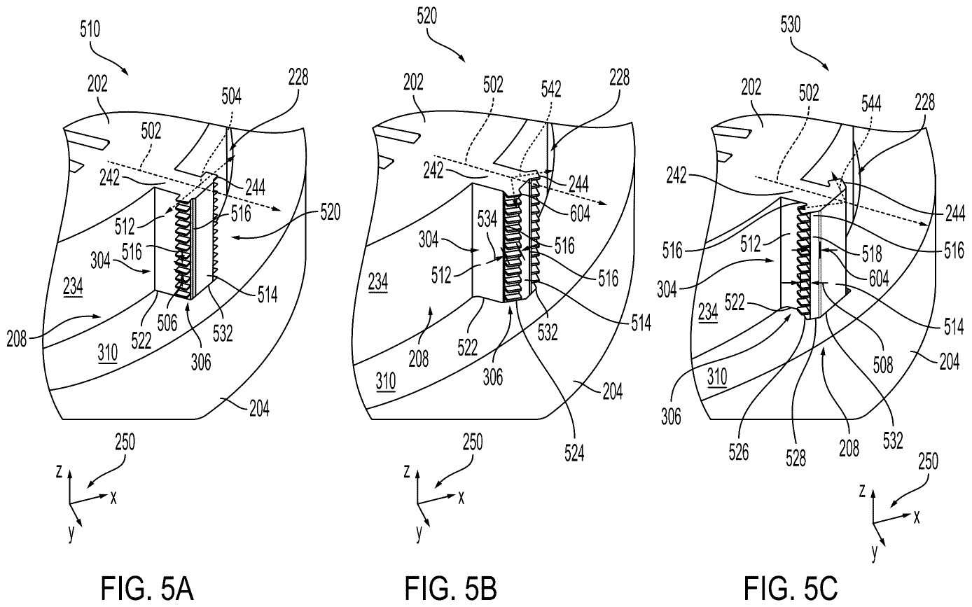

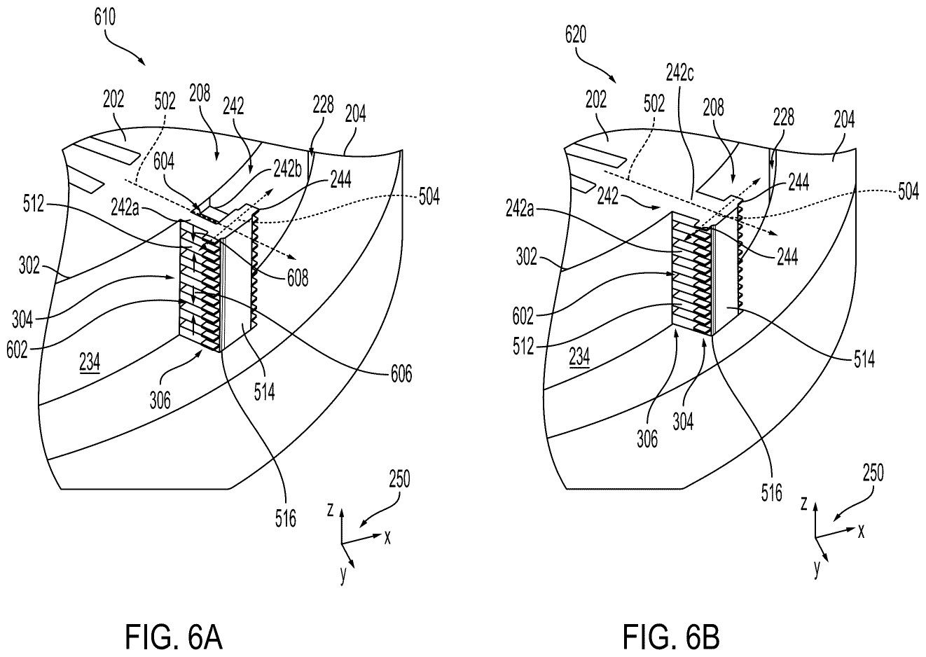

The following description relates to systems for stator fixation in an electric motor. The electric motor may be included in a vehicle propulsion system, such as an electrified power train. An example of such a vehicle is shown schematically in FIG. 1. The electric motor may include a stator fixed to a housing and a rotor positioned within and coaxial with the stator. An example of the electric motor is shown in FIG. 2, wherein the stator is fixed to the housing in accordance with the present disclosure. Specifically, the view shown in FIG. 2 is looking down an axis of rotation of the rotor. The stator may be fixed to the housing via ears and tabs formed into at least some lamination layers the stator comprises fitting with recesses formed into the housing such that the tabs bend. In this way, the stator may be fixed to the housing without axially compressing the stator. There may be three or more sets of ears and tabs radially arranged about the stator, where the three or more sets balance each other, centering the stator about the axis of rotor rotation, as shown in the examples provided in FIGS. 3 and 4. The stator may be inserted axially into the housing such that the ears protrude radially into the recesses and the tabs bend. In this way, the tabs may create a holding force for the stator according to the frictional coefficient between the tabs and the recesses, and the residual normal force from each bent tab. The ears and tabs may take a variety of shapes to achieve fixation. For example, an angle sweep at which the tabs extend from the ears may be adjusted, as shown in FIGS. 5A-5C. Further, shapes of the ears may be adjusted to allow flow of fluid, such as coolant fluid, continuously around the stator, as shown in FIGS. 6A and 6B. FIGS. 3-6B are shown approximately to scale, though other relative dimensions may be implemented.

Turning to FIG. 1, an example of a vehicle 10 with a propulsion system 11 (e.g., electric propulsion system) is shown. Propulsion system 11 includes an electric machine 14 (e.g., energy conversion device). The electric machine 14 may be incorporated into an axle of the vehicle 10. The electric machine 14 is controlled via controller 50. In some examples, the propulsion system 11 may further include an engine 72, where the engine 72 may be an internal combustion engine.

The electric machine 14 is further shown coupled to an energy storage device 16, which may include a battery (e.g., traction battery), a capacitor, inductor, or other electric energy storage device. The electric machine 14 can be operated to convert mechanical energy received from the vehicle driveline into a form of energy suitable for storage by the energy storage device (e.g., provide a generator operation). The electric machine 14 can also be operated to supply an output (power, work, torque, speed, etc. ,) to drive wheels 18 (e.g., provide a motor operation). It should be appreciated that the electric machine 14 may, in some embodiments, function only as a motor, only as a generator, or both a motor and generator, among various other components used for providing the appropriate conversion of energy between the energy storage device and the vehicle drive wheels. For instance, the electric machine 14 may include a motor, a generator, integrated starter generator, starter alternator, among others and combinations thereof. The electric machine 14 may also include or be coupled to an inverter 30. The inverter 30 may be configured to condition electrical energy in and out of the energy storage device (e.g., high voltage battery). However, in other examples, the vehicle may not include an inverter.

The energy storage device 16 may be selectively coupled to an external energy source 19. For example, the energy storage device 16 device may be periodically coupled to a charging station (e.g., commercial or residential charging station), portable energy storage device, etc., to allow the energy storage device 16 to be recharged.

The electric machine 14 may couple to a torque converter 20. The torque converter 20 may be a fluid coupling designed to transfer rotational input from the electric machine 14 to a driveline 22. The driveline 22 includes a transmission with gearing and other suitable mechanical components (e.g., a gearbox, axles, transfer cases, etc.) designed to transfer rotational motion to the drive wheels 18. The drive wheels 18 may be supported by and drive vehicle 10 across a surface 21. The torque converter 20 and the electric machine 14 are depicted as an interconnected unit. However, in other examples, the torque converter 20 and the electric machine 14 may include discrete enclosures.

The electric machine 14 may include one or more clutches designed to selectively rotationally couple the rotor of the electric machine 14 to the torque converter 20. For instance, the clutch or clutches may each include plates, splines, and/or other suitable mechanical components, allowing the machine to be rotationally connected as well as disconnected from the engine 72 or the torque converter 20.

The depicted connections between electric machine 14, driveline 22, and drive wheel 18 indicate transmission of mechanical energy from one component to another, whereas the connections between the electric machine 14 and the energy storage device 16 may indicate transmission of a variety of energy forms such as electrical, mechanical, etc. For example, torque may be transmitted from the electric machine 14 to drive the drive wheels 18 via the driveline 22. As described above, the electric machine 14 may be configured to operate in a generator mode and/or a motor mode, wherein electric machine 14 may operate as a generator and/or a motor, respectively. In a generator mode, propulsion system 11 receives some or all of the output from electric machine 14, which reduces the amount of drive output delivered to the drive wheel 18, or the amount of caliper torque to the drive wheel 18. Operations of the vehicle 10 that use the generator mode may be employed, for example, to achieve energy efficiency gains through regenerative operation, increased engine efficiency (if included), etc. Further, the output received by the electric machine 14 may be used to charge the energy storage device 16. In motor mode, the electric machine 14 may supply mechanical output to the driveline 22, for example by using electrical energy stored in an electric battery. Additionally, the engine 72 may supply rotational output to the driveline 22, in some instances.

The electric machine 14 may also couple to a cooling system 32 adapted to deliver coolant fluid to the electric machine 14 in order to reduce a temperature thereof.

In examples where the vehicle 10 comprises an engine 72, the engine 72 may have an output coupled to the torque converter 20 and may be incorporated into the axle of the vehicle. The engine 72 may be controlled via a controller 50. Both the engine 72 and electric machine 14 may act as movers to drive the vehicle 10. For example, the vehicle 10 may be a hybrid vehicle. In examples including engine 72, rotational energy, such as in the form of torque, from the engine 72 or other rotational and mechanical energy from components of the vehicle may be converted into electrical energy via the electric machine 14. Energy conversion from rotational energy or other mechanical energy may occur when the engine 72 or other components are drivingly coupled to the electric machine 14 and the electric machine 14 is in the generator mode. The output of the electric machine 14 to the torque converter 20 may act as an input for the transfer and transformation of torque into electrical energy during hybrid operations.

The controller 50 receives signals from the various sensors of FIG. 1 and employs the various actuators of FIG. 1 to adjust vehicle operation based on the received signals and instructions stored in non-transitory memory of the controller 50. Specifically, controller 50 is shown in FIG. 1 as a conventional microcomputer including: microprocessor unit 52, input/output ports 54, read-only memory 56, random access memory 58, keep alive memory 59, and a conventional data bus. Controller 50 is configured to receive various signals from sensors coupled to the propulsion system 11 and send command signals to actuators in components in the vehicle, such as the electric machine 14. Additionally, the controller 50 is also configured to receive pedal position (PP) of a pedal 62 actuated by a user 64. The PP may be estimated by and received from a pedal position sensor 60 coupled to the pedal 62. Therefore, in one example, the controller 50 may receive a pedal position signal and adjust actuators in the electric machine 14 based the pedal position signal to vary the rotational output of the electric machine 14. The sensors communicating with the controller 50 may include an electric machine sensor (e.g., resolver or Hall effect sensor for sensing a rotor position of the electric machine), and wheel speed sensor 70, accelerometer, etc.

The electric machine 14 may comprise a rotor and a stator, wherein the stator circumferentially surrounds the rotor with a gap maintained therebetween. Further, the stator may be secured to a housing such that the stator is fixed concentric with the rotor and centered about an axis of rotation of the rotor. For example, the electric machine may include a laminated circumferential stator comprising at least three integral radially and outwardly extending protrusions with tabs uniformly distributed around a perimeter of the stator, and a housing comprising recesses adapted to accommodate the protrusions, where the tabs are adapted to bend upon insertion of the stator into the housing to secure the stator to the housing. In this way, the stator and the rotor may be coaxially positioned to prevent increased NVH levels and decreased efficiency resulting from axial misalignment. For example, the coaxial positioning of the stator and rotor may prevent the NVH levels from rising above an NVH threshold. Likewise, the coaxially positioning of the stator may prevent a conversion efficiency of converting electrical energy to rotational energy, such as torque, from falling below a first efficiency threshold, and/or prevent another conversion efficiency of converting rotational energy to electrical energy from falling below a second threshold.

For example, turning to FIG. 2, a view 200 is shown of the electric machine 14. A set of reference axes 250, including an x-axis, a y-axis, and a z-axis, are provided in FIGS. 2-6. The z-axis may be a longitudinal axis for the electric machine 14. The y-axis and the x-axis are perpendicular to the z-axis, where the x-axis may be a lateral axis, and the y-axis may be a vertical axis. Additionally, the z-axis may be a horizontal axis with respect to gravity. However, in other examples, the reference axes may have other orientations.

The view 200 is shown looking down a rotational axis 252 parallel with the z-axis about which the electric machine 14 is centered. Specifically, a housing 204, a stator 202, and a rotor 206 may be concentrically centered about the rotational axis 252. The housing 204 may circumferentially surround the stator 202, and the stator 202 may circumferentially surround the rotor 206. An air gap 212 may be interposed between the stator 202 and the rotor 206. Due to the stator fixation system disclosed herein, the air gap 212 may have a more uniform thickness, where the thickness is a radial distance between the rotor 206 and the stator 202. The housing 204 and the rotor 206 may be coaxial. Thus, fixing the stator 202 coaxially to the housing 204 aligns the rotor 206 and the stator 202 coaxially, such that the rotor 206 and the stator 202 are coaxially centered around the rotational axis 252. In this way, rotational load on the rotor 206 may be more balanced, thereby reducing NVH levels and increasing efficiency.

The housing 204 may be annular shaped with an inner surface 222 and an outer surface 224. The outer surface 224 may be cylindrical. The inner surface 222 may be a modified cylindrical shape with recesses 210 tunneling partially through a radial thickness 226 of the housing 204. The recesses 210 may be equidistantly radially arranged recesses such that the recesses 210 are uniformly distributed about an inner circumference of the housing 204. The recesses 210 may extend along a length of the housing 204 parallel with the rotational axis 252 such that the recesses 210 extend through an axial thickness of the housing. The recesses 210 may include three or more walls shaped and oriented according to protrusions 208 of the stator. For example, the recesses 210 may be rectangular-shaped in x-y planes, as shown in FIG. 2. However, the recesses 210 may take other shapes depending on configurations of the protrusions 208, as described further in regards to FIGS. 5A-6B. There may be three or more recesses 210 in the housing 204. The three or more recesses 210 may be equidistantly spaced along the inner surface 222. Thus, the recesses 210 may be uniformly arranged around the inner surface 222 of the housing 204. The recesses 210 may extend radially outward from the inner surface 222 and into the material of the housing 204.

The stator 202 may be of annular shape with an inner surface 232 and an outer surface 234. The stator 202 may comprise a plurality of lamination layers stacked along the axis 252 in face sharing contact. In this way, the stator 202 may be a laminated circumferential stator. The lamination layers may be flat in x-y planes and of roughly annular shape. The plurality of lamination layers may have varying shapes form each other. For example, shapes of the protrusions 208 may be different for some lamination layers than others. In addition to the protrusions 208, the plurality of lamination layers may comprise holes, notches, and other features which are axially aligned. For example, central holes defining the inner surface 232 may be axially aligned to form the opening where the rotor 206 is positioned. For another example, the lamination layers may include slots 246 which are aligned to form through holes extending through the stator parallel with the axis 252. In some examples, the slots 246 may be fluidically coupled with the air gap 212, as shown in FIG. 2. However, in other examples, the slots 246 may be separate from the air gap 212. The slots 246 may be spaced away from the outer surface 234 by a distance 248 such that the slots 246 are separated from the second gap 228. The distance 248 may be less than a radial thickness 254 of the stator 202, where the radial thickness 254 is the distance between the inner surface 232 and the outer surface 234. A sum of a radial length 256 of the slots 246 and the distance 248 may be less than or equal to the radial thickness 254. In this way, the slots 246 may not intersect outer edges of the lamination layers that form the outer surface 234. Further, the slots 246 may also be spaced away from the protrusions 208 by the distance 248. Windings may be positioned within the through holes to prompt rotation of the rotor 206 about the axis 252 via electromagnetic interaction. The lamination layers may be shaped differently than shown in FIG. 2 without departing from the scope of the present disclosure. For example, the slots 246 may be shaped differently or there may be a different number of slots 246 radially arranged about the lamination layers.

In at least some examples, a second gap 228 may be formed between the outer surface 234 and the inner surface 222. In such examples, coolant fluid may be allowed to flow around the stator 202 in the gap 228 radially between the stator 202 and the housing 204 to reduce a temperature of at least parts of the electric machine 14, such as the stator 202. For example, a cooling system such as the cooling system 32 of FIG. 1 may pump coolant fluid through the electric machine 14 such that coolant flows in the gap 228.

There may be equal numbers of protrusions 208 and recesses 210. Correspondingly, there may be three or more protrusions 208 protruding radially and outwardly from the stator 202. The three or more protrusions 208 may be equidistantly spaced along an outer surface 234 of the stator 202 such that the protrusions 208 and the recesses 210 may radially align. Thus, the protrusions 208 may be uniformly distributed around a perimeter of the stator 202, where the perimeter may be a circumference of the outer surface 234.

Each protrusion 208 may be shaped with a maximum width 236 greater than a width 238 of the recess 210 such that from an axial view, such as the view 200, the protrusions 208 overlap with the housing 204. The maximum width 236 and the width 238 may be transverse dimensions that are perpendicular with radial directions, such as the direction 240, by which the protrusions 208 extend into the recesses 210. Thus, parts of the protrusions 208 may bend upon insertion of the stator 202 into the housing 204. For example, the protrusions 208 may comprise integral ears 242 and tabs 244. The ears 242 and the tabs 244 may be integral with the lamination layers. The ears 242 may extend radially outwards (e.g., away from the axis 252) and the tabs 244 may extend transversely from the ears 242, in at least some examples. Further details as to the shapes of the protrusions 208 and the recesses 210 are provided in regards to FIGS. 5A-6B.

In this way, balanced holding forces about the axis 252 imposed by interaction between the recesses 210 and protrusions 208 may stabilize and center the stator 202 about the axis 252 such that the stator 202 is concentric with the housing 204 and consequently, concentric with the rotor 206. Such a non-compressive stator fixation configuration may be more precise in maintaining concentric positioning than other means. For example, bolts extending through holes in the stator and the housing may be inserted and fastened to holes. Due to tolerances of the bolts and holes, axial misalignment of the stator with the rotational axis of the rotor may occur at a greater magnitude compared to the protrusions 208 fastening the stator 202 to the housing 204. Further, axial compression imposed by the bolts may further reduce efficiency. Thus, stator fixation in accordance with the present disclosure may reduce NVH levels and increase efficiency compared to such other stator fixation examples.

Turning to FIG. 3, a view 300 is shown of an example of the stator 202 and the housing 204. As described above, the stator 202 may be inserted into the housing 204 such that the protrusions 208 extend into the recesses 210 and the tabs 244 bend to fix the stator centered about the axis 252. In at least some examples, the stator 202 and the housing 204 may be separated with a gap therebetween.

A length 312 of the stator 202 may be longer than a length 314 of the housing 204 such that the stator 202 extends axially beyond the housing. For example, an end surface 308 of the stator 202 may not be surrounded by the housing 204. In other examples, the length 312 and the length 314 may be approximately the same such that the end surface 308 is flush with a surface 310 of the housing 204. In yet other examples, the housing 204 may extend beyond the stator 202 on one or both axial ends.

The stator 202 may be laminated such that the stator 202 comprises lamination layers 302. The lamination layers 302 of the stator 202 may be stacked along the axis 252 and aligned such that the protrusions 208 comprise stacks of ears 242 and tabs 244. For example, the ears 242 of each lamination layer 302 may axially align such as to be centered around common axes. Likewise, the tabs 244 may axially align such as to be centered around common axes. The ears 242 may axially align to form ear stacks 304, and the tabs 244 of the lamination layers 302 may axially align to form tab stacks 306. The tabs 244 may extend laterally from the ear stacks 304. Specifically, the ears 242 may be axially aligned to form three or more ear stacks 304 and the tabs 244 may be axially aligned to form two or more tab stacks 306 protruding symmetrically from each ear stack 304.

In some examples, some of the lamination layers 302 may not include tabs 244. Thus, the tab stacks 306 may comprise tabs 244 spaced away from one another. A distance (e.g., distance 506 of FIG. 5A) between the tabs 244 within a tab stack 306 may depend on a frequency of lamination layers comprising tabs, for example a number of lamination layers 302 without tabs 244 positioned between two lamination layers 302 with tabs 244. The frequency of lamination layers 302 with tabs 244 may be even such that the distance between adjacent tabs is approximately the same throughout the tab stacks 306.

When inserting the stator 202 into the housing 204, the stator 202 may be pushed axially (e.g., downwards in the orientation shown in FIG. 3) into the housing 204 against force of the tabs 244. The tabs 244 bend with respect to the ears 242 upon contact with the surface 310 and upon sliding down walls of the recesses 210. The resulting normal force may maintain concentric positioning of the housing 204 and the stator about the axis 252, thereby aligning the stator 202 coaxially with a rotor positioned in the stator, such as the rotor 206 of FIG. 1.

The example of stator 202 shown in FIG. 3 comprises three protrusions 208. However, in other examples, there may be four or more uniformly distributed protrusions 208. For example, turning to FIG. 4, a view 400 is shown of another example of the stator 202 and the housing 204 where the stator comprises four protrusions 208. The protrusions 208 may be evenly angularly distributed such that examples with four protrusions such as the example shown in FIG. 4 have approximately 90 degrees about the axis 252 between each protrusion 208. In other examples, different spaces may be interposed between different numbers of protrusions 208. For example, there may be five protrusions in other examples with a smaller angular distance between each protrusion 208. In this way, the stator 202 may comprise three or more protrusions 208 uniformly distributed around the stator 202 with approximately the same angular distance between adjacent protrusions 208. More specifically, the three or more protrusions 208 may be evenly distributed around an outer perimeter of the stator 202 lying on the outer surface 234.

In addition to a number of protrusions 208, a configuration of the protrusions 208 may be adjusted. For example, a change in angle sweep of the tabs 244 to be angled more inboard or outboard may increase the compression or tension through the ear 242 and adjust the radial and tangential fixation force correspondingly. Turning to FIGS. 5A, 5B, and 5C, a first view 510, a second view 520, and a third view 530 are respectively shown of exemplary configurations of the protrusions 208 and the recesses 210 where the angle sweep of the tabs 244 is varied between examples.

As described above, two or more tab stacks 306 comprising axially aligned tabs 244 may be integral with each protrusion 208. In the example shown in the first view 510, the tabs 244 extend transversely along direction 504, at a perpendicular angle to the radial direction 502 along which the ear 242 extends from the outer surface 234. In the examples shown in the second view 520 and the third view 530, the tabs 244 extend at a non-zero, non-perpendicular angle with the radial direction 502. Thus, the directions of tabs 244 extending away from the ears 242 are not directly opposite in such examples. However, the directions may be symmetrical across the arrow showing the radial direction 502. For example, the second view 520 shows an example of the tabs 244 directed more outboard (e.g., angled further away from the outer surface 234) along directions 542, and the third view 530 shows the tabs 244 directed more inboard (e.g., angled more towards the outer surface 234) along directions 544. Thus, the tabs 244 may be symmetrically angled along directions (e.g., directions 504, 542, or 544) at any non-zero angle with the radial direction 502 by which the ears 242 protrude. In other words, the tab stacks 306 may protrude symmetrically about radial directions 502 by which the protrusions 208 extend.

Each ear stack 304 may include an end 514 and two sides 512, where the sides 512 are parallel to one another and perpendicular with the end 514. The end 514 and the sides 512 may be defined by edges of the lamination layers 302 aligned such that the edges are flush with one another, the flush edges of the lamination layers forming surfaces of the end 514 and the sides 512. The sides 512 and the end 514 may be described herein as continuous surfaces when adjacent flush edges are not spaced apart with an air gap therebetween. The sides 512 and the end 514 may be described herein as discontinuous surfaces when two edges are spaced apart at one or more locations with an air gap therebetween. The end 514 may be parallel with a plane tangential to the stator 202 at the location where the protrusion 208 extends. The end 514 may be perpendicular with the direction 502.

The tabs 244 may be rectangular-shaped with rounded corners. Further, the points at which the tabs 244 meet the ears 242 may be rounded to reduce stress on such points when the tabs bend upon insertion of the stator 202 into the housing 204. Thus, rounded or chamfered edges 516 may be interposed between the sides 512 and the end 514. There may be two points at which each of the tabs 244 meets the ears 242, one between the tab 244 and the end 514 and one between the tab 244 and the side 512.

For example, in the example shown in the view 510, the tabs 244 extend transversely along the directions 504, perpendicular to the sides 512. The tabs 244 may be spaced away from the end 514 in such an example, with rounded or chamfered edge 516 between the tabs 244 and the end 514. Further, another rounded or chamfered edge 516 may be positioned between the tab stacks 306 and the sides 512. As another example, in the example shown in the second view 520, the tabs 244 extend in the directions 542 outboard at a non-zero, non-perpendicular angle from the sides 512 with rounded or chamfered edges 516 between the tab stacks 306 and the sides 512 and between the tab stacks 306 and the end 514. As yet another example, in the example shown in the third view 530, the tabs 244 extend in the directions 544 inboard at a non-zero, non-perpendicular angle from the sides 512, resulting in an angled side 518 between the end 514 and each of the tab stacks 306. Additionally, a rounded or chamfered edge 516 may be formed between the angled sides 518 and the end 514, and between the tab stacks 306 and the sides 512.

Accordingly, the recesses 210 may be shaped differently depending on configurations of the protrusions 208. For example, the recesses may be shaped according to the angle sweep of the tabs 244 (e.g., transversal, inboard, or outboard). The recesses 210 may be defined by three or more walls. The walls may extend along the z-axis through the axial thickness of the housing 204. For example, the recess 210 may comprise an end wall 532 and two side walls 522. The end wall 532 may be parallel with the end 514. The side walls 522 may be parallel with the sides 512. The end 514 and the sides 512 may be spaced away from the end wall 532 and the side walls 522, respectively, in at least some examples. For example, the tabs 244 may space the sides 512 from the side walls 522. However, in some examples, the end wall 532 may be in face sharing contact with the end 514. Further, there may be more than two tab stacks 306 per protrusion in some examples. For example, in addition to the transversely, inboard, or outboard extending tabs 244 shown in FIGS. 2-6B, there may be additional tabs extending from the end 514 along the radial direction 502 by which the ears 242 protrude where the additional tabs bend against the end wall 532 and space the end wall 532 away from the end 514.

Further, walls of the recesses 210 which the tabs 244 bend against may be perpendicular to the directions 504 along which the tabs extend. In the example of the view 510, the side walls 522 may be perpendicular to the directions 504. In the example of the second view 520, angled walls 524 may connect the side walls 522 with the end wall 532, wherein the angled walls 524 are perpendicular with the directions 504. In the example of the third view 530, first angled walls 526 may be oriented perpendicular with the directions 504 and second angled walls 528 may connect the first angled walls with the end wall 532, where the second angled walls 528 are parallel with the angled side 518.

Proportions of the tabs, such as a length 508 by which the tabs 244 extend from the ears 242 along the direction 504, a width 534 of the tabs perpendicular with the direction 504, and a distance 506 between the adjacent tabs 244, may be selected according to a desired holding force resulting from bending of the tabs 244. For example, tabs 244 with a greater length 508 and/or width 534 may produce greater holding force due to greater resistance to bending. For another example, tab stacks 306 with a greater number of tabs 244 having smaller distance 506 between the tabs 244 may produce a greater holding force due to more tabs 244 pressing against the recesses 210. Additionally, the tabs 244 are shown as being approximately rectangular, however the tabs may take other shapes, such as trapezoidal, without departing from the scope of the present disclosure. Thus, configurations of the tabs 244, including angles, relative proportions, and shapes of the tabs, may be adjusted to an application to accommodate different stator configurations. For example, greater holding force may be demanded for stators of greater size and/or weight.

Further, in addition to configurations of the tabs 244, configurations of the ears 242 may be adjusted. For example, turning to FIGS. 6A and 6B, a first view 610 and a second view 620 are respectively shown of exemplary configurations of the protrusions 208 and the recesses 210 where the ears 242 vary between the two examples.

The examples shown in FIGS. 3-5C comprise lamination layers all having the same ear shapes and orientations such that the ear stacks 304 are solid. The ear stacks 304 may be rectangular prism-shaped in such examples with no openings formed therein. Thus, such solid ear stacks 304 may not be permeable to fluid, such as coolant oil. However, it may be advantageous to form an ear stack 304 with pathways therethrough, for example to allow flow of coolant fluid continuously around the outer surface 234 without being blocked by solid ear stacks 304. To form such pathways, openings may be formed by alternating sections of two or more different ear shapes and/or orientations. Examples are shown in first view 610 and second view 620 respectively provided in FIGS. 6A and 6B for creating openings in the protrusions 208 with patterns of different ear shapes and/or orientations. Thus, the first view 610 and the second view 620 show examples where the ear stacks 304 may not fluidically separate sections of the gap 228 between the stator 202 and the housing 204.

Focusing on FIG. 6A, the first view 610 shows an example where orientations of the ears 242 are varied between lamination layers 302. There may be first ears 242a and second ears 242b, where the first ears 242a and the second ears 242b are of the same non-symmetrical shape and oriented oppositely such that transversal openings 602 and axial openings 604 are formed. The ears 242 in such examples may be L-shaped, in at least some examples. In other examples, the ears 242 may take other non-symmetrical shapes, such as a modified rectangular shape with one or more cut-outs. For example, the lamination layers 302 may all be of the same ear shape, and some oriented differently (e.g., flipped over) relative to others such that the first ears 242a and the second ears 242b are oppositely oriented. In this way, the first ears 242a and the second ears 242b may be shaped as reflections of each other across the radial direction 502.

There may be two or more tabs 244 extending transversely, inboard, or outboard from each ear 242, as described above. The first ears 242a and the second ears 242b may be axially aligned such that the tabs 244 are axially aligned into the tab stacks 306, the end 514 is a continuous surface, and the sides 512 comprise a plurality of coplanar surfaces. The lamination layers 302 may be patterned such that groups of first ears 242a and groups of second ears 242b are alternated. For example, a plurality of lamination layers comprising first ears 242a may be layered to form a first group of thickness 608, and a plurality of lamination layers comprising second ears 242b may be layered to form a second group of approximately the same thickness 608 adjacent to the first group. Further, a plurality of lamination layers comprising first ears 242a may be layered to form a third group of approximately the same thickness 608, where the third group is stacked with and interposed between the first group and the second group. In at least some examples, the thickness 608 may be approximately the same for each group of lamination layers comprising similarly oriented adjacent ears (e.g., either first ears 242a or second ears 242b). Thus, a distance 606 between adjacent groups of the same ear orientation (e.g., the first group and the third group) may be approximately equal to the thickness 608 of each of the groups. In other words, the distance 606 may be a uniform distance. Further, the thickness 608 and the distance 606 may be approximately the same size. In this way, groups of lamination layers 302 comprising either the first ears 242a or the second ears 242b may be alternated in a repeating pattern such that the sides 512 are discontinuous sides and pathways through the ear stacks 304 allow fluid to flow transversally through the ear stacks 304 in the gap 228 around the outer surface 234.

Further, the tabs 244 may be formed into some but not all of the lamination layers 302 on a frequency that spaces the tabs 244 in each tab stack 306 apart as described above. For example, there may be one lamination layer 302 per group comprising tabs 244. In other examples, the frequency of tabs 244 may be different than the number of lamination layers 302 per group. The tabs 244 may be arranged similarly as described with regards to any of the examples of FIGS. 5A-5C. Thus, the tabs 244 may extend transversely as shown, or the tabs may be directed inboard or outboard as described above.

Focusing on FIG. 6B, the second view 620 shows another example wherein shapes and orientations of the ears 242 are varied between lamination layers 302. The example of the second view 620 includes some of the first ears 242a and some of the second ears 242b, where the first ears 242a and the second ears 242b are oriented differently as described above. The example of the second view 620 further includes third ears 242c which are rectangular-shaped and symmetrical about the direction 502, similarly to the examples shown in FIGS. 2-5C. Thus, the third ears 242c are shaped differently from the first ears 242a and the second ears 242b. The first ears 242a and the second ears 242b may be arranged in alternating groups as described above. The third ears 242c may be positioned at one or both axial ends of the ear stacks 304. In this way, the groups of first ears 242a and the groups of the second ears 242b may be sandwiched between two third ears 242c. The third ears 242c may also be interspersed throughout the ear stack 304. The third ears 242c may provide additional support to the ear stack 304, compared to the example in the first view 610 which does not include the third ears 242c.

Examples where the ear stacks 304 comprise openings such as in the first view 610 and the second view 620 may have discontinuous sides 512, in contrast with solid ear stacks which have continuous sides 512. Further, in some examples, ends 514 may be discontinuous as well, for example when not all of the lamination layers 302 comprise ears. In this way, the openings in the sides 512 (and sometimes the end 514) allow coolant fluid to flow around a whole circumference of the stator 202. As described above, the ears 242 may be patterned with varying shapes and/or orientations according to a desired flow of coolant fluid around the stator 202. For example, the ear stacks 304 may have alternating sections that either vary axially or transversely to the stator 202 to allow a cooling medium to flow continuously around the perimeter of the stator 202.

Other configuration of the protrusions 208 and the recesses 210 are possible without departing from the scope of the present disclosure. Combinations of aspects of the protrusion 208 examples of FIGS. 5A-6B may be combined in some examples. For example, the tabs 244 may be directed outbound such as shown in FIG. 5B and the ears 242 may be staggered such as shown in FIG. 6B. Further, the tabs 244 may be rectangular-shaped with corners and points at which the tabs meet the ears being rounded or chamfered to form a rounded or chamfered edge, as described above. However, the tabs 244 may take other shapes in other examples according to desired holding forces for stabilizing and centering stator fixation to the housing. Likewise, the ears 242 may be L-shaped or rectangular-shaped in at least some examples as described above, but may take other shapes in other examples according to desired flow of fluid through and/or around the ear stacks 304.

The protrusions 208 may be substantially the same as each other and the corresponding recesses 210 may be substantially the same as each other in a given electric machine, such as the electric machine 14 of FIGS. 1 and 2. For example, all three protrusions 208 of the example shown in FIG. 3 may have approximately the same shape and dimensions. Similarly, all four protrusions 208 of the example shown in FIG. 4 may have approximately the same shape and dimensions. Likewise, the recesses 210 of the respective examples may have approximately the same shape and dimensions as each other. Further, each tab stack 306 may consist of the same number of tabs 244 such that stabilizing forces provided by resistance of the tabs 244 bending against the recesses 210 are symmetrical, thereby centering the stator 202 with the housing 204.

The technical effect of electric machines with stator fixation in accordance with the present disclosure is to align the stator of the electric machine coaxially with the rotor of the electric machine with reduced offset compared to other fixation systems for attaching the stator to the housing, such as those including bolts. In this way, rotational balance of the rotor may be increased due to an air gap between the stator and the rotor being more even (e.g., uniform) in thickness, thereby reducing NVH levels and increasing efficiency of energy conversion from electricity provided to the electric machine to rotational mechanical energy. Further, stator fixation without compressive forces may increase efficiency compared to stator fixation achieved by axial compression, for example with axially extending bolts.

FIGS. 1-6B show example configurations with relative positioning of the various components. FIGS. 3-6B are shown approximately to scale, though other dimensions may be used. Unless otherwise noted, if shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example.

In another representation, a hybrid vehicle comprises: an electric machine including a stator with radially and outwardly extending protrusions adapted to interact with recesses in a housing such that transversally, inboard, or outboard extending tabs of the protrusions bend to fix and center the stator with the housing.

It will be appreciated that the configurations and routines disclosed herein are exemplary in nature, and that these specific embodiments are not to be considered in a limiting sense, because numerous variations are possible. For example, the above technology can be applied to V-6, I-4, I-6, V-12, opposed 4, and other engine types. Moreover, unless explicitly stated to the contrary, the terms “first,” “second,” “third,” and the like are not intended to denote any order, position, quantity, or importance, but rather are used merely as labels to distinguish one element from another. The subject matter of the present disclosure includes all novel and non-obvious combinations and sub-combinations of the various systems and configurations, and other features, functions, and/or properties disclosed herein.

As used herein, the term “approximately” is construed to mean plus or minus five percent of the range unless otherwise specified.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. An electric machine, comprising:
a laminated circumferential stator comprising at least three integral radially and outwardly extending protrusions uniformly distributed around a perimeter of the stator, where each protrusion comprises tabs; and
a housing comprising recesses adapted to accommodate the protrusions, where the tabs are adapted to bend upon insertion of the stator into the housing to fix the stator to the housing.

2. The electric machine of claim 1, wherein lamination layers of the stator do not all include tabs such that the tabs are axially spaced apart.

3. The electric machine of claim 1, wherein two or more tab stacks are formed at each protrusion by the tabs being axially aligned, and wherein the tab stacks protrude symmetrically about radial directions by which the protrusions extend.

4. The electric machine of claim 3, wherein the tabs extend transversely such that the tabs are perpendicular with the radial directions.

5. The electric machine of claim 3, wherein the tabs are directed inboard such that a non-zero, non-perpendicular angle is formed between the tabs and the radial directions.

6. The electric machine of claim 3, wherein the tabs are directed outboard such that a non-zero, non-perpendicular angle is formed between the tabs and the radial directions.

7. The electric machine of claim 1, wherein the recesses are shaped according to an angle sweep of the tabs such that the tabs bend against walls of the recesses that are perpendicular to the tabs.

8. An electric machine, comprising:
a housing with equidistantly radially arranged recesses;
a stator positioned within the housing, wherein the stator is fixed to the housing via ears integral with lamination layers of the stator extending radially into the recesses and tabs integral with the ears bending against walls of the recesses, wherein the ears and the tabs maintain concentric positioning of the housing and the stator.

9. The electric machine of claim 8, wherein the ears are axially aligned to form three or more ear stacks and the tabs are axially aligned to form two or more tab stacks protruding symmetrically from each ear stack.

10. The electric machine of claim 9, wherein the ear stacks each include an end and two sides formed by flush edges of the lamination layers.

11. The electric machine of claim 10, wherein the tabs are spaced away from the end with a rounded or chamfered edge between the tabs and the end.

12. The electric machine of claim 8, wherein the recesses extend partially through a radial thickness of the housing and are defined by three or more walls extending through an axial thickness of the housing.

13. The electric machine of claim 9, wherein sides of the ear stacks include openings such that fluid flows through the ear stacks.

14. The electric machine of claim 8, wherein the tabs are rectangular-shaped with corners and points at which the tabs meet the ears being rounded or chamfered.

15. An electric machine, comprising:
a rotor centered on a rotational axis;
a housing centered about the rotational axis with three or more recesses; and
a stator comprising a plurality of lamination layers circumferentially surrounding the rotor and circumferentially surrounded by the housing, the plurality of lamination layers each including three or more radially protruding ears and some of the plurality of lamination layers further including two or more tabs extending from each of the ears, wherein the stator is fixed to the housing by the tabs bending against walls of the recesses such that the rotor, the stator, and the housing are coaxial.

16. The electric machine of claim 15, wherein lamination layers including the tabs are distributed throughout the stator on a frequency such that the tabs are axially spaced apart by a uniform distance.

17. The electric machine of claim 15, wherein the plurality of lamination layers includes a first group of lamination layers comprising first ears, a second group of lamination layers comprising second ears shaped or oriented differently than the first ears, and a third group of lamination layers comprising the first ears, wherein the second group is interposed between the first group and the second group and stacked such that the first ears and the second ears are axially aligned into ear stacks.

18. The electric machine of claim 17, wherein the ear stacks include discontinuous sides through which fluid flows continuously around an outer surface of the stator.

19. The electric machine of claim 17, wherein the first group, the second group, and the third group are of approximately the same thickness.

20. The electric machine of claim 15, wherein the ears are L-shaped or rectangular-shaped.
